(19) United States
(12) Patent Application Publication
(10) Pub. No.: US 2010/0247860 A1
(43) Pub. Date: Sep. 30, 2010

(54) Configuration for Increasing the Bond Strength Between a Structural Material and Its Reinforcement

(76) Inventors: Melvin C. Sykes, Vicksburg, MS (US); Donna C. Day, New Orleans, LA (US); Philip G. Malone, Vicksburg, MS (US); Charles A. Weiss, JR., Clinton, MS (US); Earl H. Baugher, JR., Albuquerque, NM (US)

Correspondence Address: U.S. Army Corps of Engineers;Humphreys Engineer Center, ATTN: CEHEC-OC (Kingman Building), 7701 Telegraph Road, Alexandria, VA, 22315-3860, US

(21) Appl. No.: 12/793,799

(22) Filed: Jun. 4, 2010

Related U.S. Application Data
(63) Continuation-in-part of application No. 11/234,184, filed on Sep. 26, 2005.

(51) Int. Cl. B32B 3/00; B32B 38/00

(52) U.S. Cl. 428/141; 156/89.11; 216/33

(57) ABSTRACT

A method of coarse enameling material, such as the surface of conventional rebar, which increases adhesion between the surface and a matrix, such as a cement-based mortar or concrete, in which the material is embedded. In one embodiment, a glass fit is fired onto a surface to achieve an enamel finish, the finish is then cooled and heat softened. A refractory material, such as dry portland cement, is applied to the heat softened enamel, and the resultant coarse coating is then fired and cooled to produce a final hard coarse enameled surface. The reaction of the refractory component in the coarse enameled surface upon insertion in fresh mortar or concrete prevents the formation of soft precipitates at the interface of the cementitious matrix and the coarse-enameled reinforcement. One embodiment involves adding portland cement Type I-II to a softened glass frit as a final coating over an initial base coating that if fired on the steel to prevent corrosion of the underlying steel. The coarse topcoat of enamel produces a strong chemical bond between it and a concrete or mortar matrix and the base coat of enamel eliminates or significantly reduces the potential for corrosion.

### RELATED INVENTIONS

Under 35 U.S.C. §121, this application is a continuation-in-part of, and claims the benefit of, prior co-pending U.S. patent application Ser. No. 11/234,184, Publication No. 2007/0264527 A1, System and Method for Increasing the Bond Strength Between a Structural Material and Its Reinforcement, by Sykes et al., filed Sep. 26, 2005 and incorporated herein by reference.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees. Please contact Phillip Stewart at 601 634-4113.

### BACKGROUND

Metals embedded in concrete typically form very poor physical bonds with the contacting cementitious matrix because there are no coupling compounds that form between the cementitious matrix and the metal. Putting a hard, smooth coating, such as a ceramic, on the metal helps to corrosion proof the metal, given that the coating is alkali-resistant, but does nothing to improve the bond between the now ceramic-coated metal and the cementitious mixture.

In select embodiments of the present invention, alkali-resistant nickel or cobalt-rich glass frits bond to the steel and the resultant porcelain (glass) surface on the steel bonds to bulk construction materials separately embedded in the top surface of the porcelain by softening the porcelain by heat and sprinkling the dry bulk construction material, typically portland Type I/II cement on the exterior of the steel. These bulk materials may comprise portland cement clinker, mica, quartz, aluminum silicate, other refractory inorganic compounds, and the like. In a common application for a stronger, corrosion-resistant, reinforced concrete, these bulk materials are preferably bound only in the surface of the porcelain, in turn bonding tightly to the calcium silicate hydrate that forms as the portland cement in the cementitious matrix hydrates.

The enameling glass (porcelain) behaves as a “coupling compound” analogous to a silane (an organic that can bond with organic polymers but containing silica that can bond to silicate in glass). The enameling glass used with select embodiments of the present invention has to contain cobalt or a suitable, but non-preferred substitute such as nickel. Cobalt content in the glass allows iron to migrate into the glass and form a chemical bond. No other known glass composition has this ability to bond to iron (nickel-rich glass may be substituted but is inferior to cobalt). The silicate composition of the glass allows it to bond also to a ceramic (such as portland cement). Portland cement is crystalline silicate and only a similar crystalline compound or a glass that has a disordered arrangement of silica, oxygen and associated cations (like sodium and calcium) can share chemical bonds effectively with an ordered silicate compound like tri-calcium silicate or di-calcium silicate (major cementing phases in portland cement).

Further, to get a good bond between a good enameling glass and calcium and sodium constituents, one must select an enameling glass that will not be destroyed by the calcium hydroxide that will form when the cement ceramic becomes calcium silicate hydrate gel, for which the pH can exceed pH 13, if there is sodium present in the portland cement. At that pH a typical sodium glass will break down and form a gel, destroying the enameling glass and the bond. Thus, what is required is an alkali-resistant glass of a special composition. The best alkali-resistant glasses are the zirconium-rich glasses. Thus a bonding enamel must be a cobalt-rich glass incorporating zirconium or like compound that allows it to be stable (i.e., not converting to gel) at an elevated pH. Further, the glass does not only have to be resistant to alkali for a short time (like alkali oven cleaner used in oven scrubbing episodes) but it has to have the long term stability similar to the glass compositions used for alkali-resistant glass fiber reinforcement in concrete. These long-term alkali resistant glasses used in concrete are not typically cobalt-rich enameling glass.

Thus, needed is a coupling compound that employs a carefully selected glass composition uniquely suited to this application, i.e., an alkali-stable, cobalt-rich bonding enamel for the special role of the glass used in enameling steel for topcoating with an appropriate bonding bulk construction material, such as portland cement.

### BRIEF DESCRIPTION OF DRAWINGS

FIG. 1 depicts an element that may be used in an embodiment of the present invention.

FIG. 2 is a photograph of a metal rod treated in accordance with an embodiment of the present invention.

FIG. 3 is a photograph of a fractured split section of a portland cement-based mortar cylinder and the rod of FIG. 2 after it has been extracted a short distance from the cylinder.

FIG. 4 is a photograph of the split section of the mortar cylinder of FIG. 3 after the rod has been removed from the mortar cylinder.

### DETAILED DESCRIPTION

The strength of the bond between reinforcing material and a matrix, as well as the corrosion resistance of the reinforcing material, is improved by applying a coating of glass fit having a low-melting temperature to reinforcing material, such as steel rods; allowing the coating to dry; firing the resultant coated reinforcing material to a temperature that at least softens the dried coating; adding material of a non-melting mineral type, i.e., refractory material, to said softened coating as a second, or surface, coating; and firing the resultant two-layer coating. This 2-layer coating increases the bond between the reinforcing material and a matrix incorporating the reinforcing material, such as concrete, yielding an improved steel rod or rebar-enforced concrete.

In select embodiments of the present invention, steel rods (such as rebar) are coated with a first coating incorporating a commercial powdered glass frit and, in a second operation, a second coating of particles of one or more refractory materials such as mica, glass slag, portland cement clinkers and the like. In select embodiments of the present invention, a base coat frit is applied and dried, and a second frit and refractory material are suspended in a liquid carrier, such as water and applied as a second coat. In select embodiments of the present invention, the first coat may be heated to softening before applying the second coat and heating the second coat to a final pre-specified temperature. Refractory materials are those materials that do not melt at temperatures that fuse (solidify) frits used in making the coatings used in select embodiments of the present invention. In all embodiments of the present invention, the refractory materials are embedded only in the top surface of the resultant product to create a rough outer surface unlike the porcelain coating found on common household appliances.

In select embodiments of the present invention, coatings or glazes (“enameling”) of a rough finish texture are fired on metal structure. The resultant “rough-enamel” coating is employed to improve the physical and chemical bonding of a variety of cement-based mortars or concretes to a variety of metals, such as steel, stainless steel, aluminum, copper and the like, or items plated with these metals.

In select embodiments of the present invention, flowable frit mixtures, preferably in a liquid carrier mixed with a thickener added to the liquid, are mixed with a refractory additive of appropriate dimension to be incorporated in a second or “top” coat yielding a rough or “bumpy” enameled top surface after firing. In select embodiments of the present invention, the refractory additives may be one or more of the following types: dry portland cement, mica, slag, and the like. These refractory additives may be applied separately to a softened groundcoat of enamel previously applied or mixed with a suitable fit and applied as a top coating above a groundcoat of enamel on reinforcing materials such as steel rebar, metal fibers, and the like. In select embodiments of the present invention, a reinforcement coated with the above “frit-bonding” combinations, yielding a rough top surface incorporating refractory material (such as bulk construction products) appropriately fired on the reinforcing material, e.g., rebar, is added as reinforcement to structural material during its flowable stage (such stage as may be present in a portland cement-based mortar paste or concrete paste) and then permitted to cure.

In select embodiments of the present invention, the selected frit for the base or ground coat needs to bond to steel. Thus, this frit contains a transition metal, e.g., nickel, cobalt, and the like, to facilitate this bond. Bonding of the “coated and fired” steel to an embedding matrix, such as concrete in its paste form, is most likely not improved by applying multiple coats of a “frit-to-steel bonding” mixture. Thus, with steel rebar for example, it is proper to use a first coat (ground coat, for example) of a suitable bonding frit and a second (top) coat that consists only of refractory material. A suitable bonding frit for steel is a groundcoat enamel that bonds directly to the steel, not to another enamel. In select embodiments of the present invention, the second (top) coating is produced by “coating” a heat-softened first (ground) coat with one or more high melting point (refractory) materials, such as a ceramic of portland cement clinkers, mica flakes, slag glass and the like. The composition of a typical alkali-resistant groundcoat enamel for steel is shown in Table 1.

TABLE 1
Composition of a typical alkali-resistant groundcoat enamel for steel

| | Amount |
|---|---|
| Constituent | (%) |
| Silicon dioxide (SiO₂) | 42.02 |
| Boron oxide (B₂O₃) | 18.41 |
| Sodium oxide (Na₂O) | 15.05 |
| Potassium oxide (K₂O) | 2.71 |
| Lithium oxide (Li₂O) | 1.06 |
| Calcium oxide (CaO) | 4.47 |
| Aluminum oxide (Al₂O₃) | 4.38 |
| Zirconium oxide (ZrO₂) | 5.04 |
| Copper oxide (CuO) | 0.07 |
| Manganese dioxide (MnO₂) | 1.39 |
| Nickel oxide (NiO) | 1.04 |
| Cobalt Oxide (Co₃O₄) | 0.93 |
| Phosphorous Pentoxide (P₂O₅) | 0.68 |
| Fluorine (F₂) | 2.75 |

In select embodiments of the present invention, a method for improving a bond between reinforcing material and a matrix incorporating the reinforcing material by establishing a strong chemical bond, comprises: selecting one or more flowable frits, such as an alkali-resistant groundcoat enamel, the frits compatible with the matrix and reinforcing material; selecting refractory material compatible with the matrix and frits; preparing one or more surfaces of the reinforcing material; applying a frit coating to the surface of the reinforcing material; drying said frit coating; heating the dried frit coating to soften it; applying the refractory material to the softened frit coating; selecting a temperature regime for firing the resultant two-part coating onto the reinforcing material; selecting a time regime for conducting the firing; firing the two-part coating on the reinforcing material at the selected temperature regime for the selected time regime; cooling the resultant coated reinforcing material; inserting the resultant cooled reinforcing material into the matrix while the matrix is flowable, and curing the resultant reinforced flowable matrix.

In select embodiments of the present invention, a method for reinforcing a matrix by incorporating an enhanced reinforcing material therein, comprises: selecting a first flowable frit compatible with at least the reinforcing material; preparing surfaces of the reinforcing material for coating by said first flowable frit; applying said first flowable frit to the surfaces of the reinforcing material; drying the applied first flowable frit; firing the applied first flowable frit on the reinforcing material at a first selected temperature regime for a first selected time period; selecting a second flowable frit compatible with the first flowable frit and at least the matrix material; selecting refractory material compatible with at least the second flowable frit and the matrix material; mixing the refractory material with the second flowable frit; applying the resultant mixed coating as the top coating of said reinforcing material; selecting a second temperature regime and second time period for firing the top coating onto the first fired coating; firing the top coating on the first fired coating at the selected second temperature regime for the selected second time period; cooling the resultant coated reinforcing material; inserting the resultant cooled coated reinforcing material into the matrix while the matrix is flowable, and curing the resultant reinforced flowable matrix.

In select embodiments of the present invention, a method for producing an enhanced reinforcing material for incorporating in a matrix comprises: selecting a first flowable frit compatible with at least the reinforcing material; preparing surfaces of the reinforcing material for coating by said first flowable frit; applying said first flowable frit to the surfaces of the reinforcing material; drying the applied first flowable frit; firing the applied first flowable fit on the reinforcing material at a first selected temperature regime for a first selected time period; selecting a second flowable frit compatible with the first flowable frit and at least the matrix material; selecting refractory material compatible with at least the second flowable frit and the matrix material; mixing the refractory material with the second flowable frit; applying the resultant mixed coating as the top coating of said reinforcing material; selecting a second temperature regime and second time period for firing the top coating onto the first fired coating; and firing the top coating on the first fired coating at the selected second temperature regime for the selected second time period.

In select embodiments of the present invention, a method for producing an enhanced reinforcing material for incorporating in a matrix comprises: selecting a first flowable frit compatible with at least the reinforcing material; preparing surfaces of the reinforcing material for coating by said first flowable frit; applying said first flowable frit to the surfaces of the reinforcing material; drying the applied first flowable frit; firing the applied first flowable fit on the reinforcing material at a first selected temperature regime for a first selected time period; selecting a second flowable fit compatible with the first flowable frit and at least the matrix material; selecting refractory material compatible with at least the second flowable frit and the matrix material; mixing the refractory material with the second flowable frit; applying the resultant mixed coating as the top coating of said reinforcing material; selecting a second temperature regime and second time period for firing the top coating onto the first fired coating; and firing the top coating on the first fired coating at the selected second temperature regime for the selected second time period.

In select embodiments of the present invention, a configuration is affixed to a base reinforcing material for improving the bond, in particular the chemical bond, between the base reinforcing material and an initially flowable matrix incorporating the enhanced reinforcing material. The configuration comprises a flowable fit compatible with at least the base reinforcing material and refractory material compatible with at least the matrix and the flowable frit, such that: surfaces of the reinforcing material are prepared for accepting the flowable frit; the flowable frit is applied to the prepared surfaces; the flowable frit is dried; the dried frit is fired on the reinforcing material at a first pre-specified temperature regime for a first pre-specified time; the resultant coated reinforcing material is cooled; the resultant cooled enhanced reinforcing material is heated until the coating is softened; the refractory material is applied to the surface of the softened coating and the resultant two-part coating is fired at a pre-specified temperature regime for a pre-specified time.

In select embodiments of the present invention, an enhanced reinforcing structure for improving bonding, in particular chemical bonding, of the enhanced reinforcing structure to a matrix incorporating the enhanced reinforcing structure comprises: base reinforcing structures, having one or more surfaces; a flowable frit compatible with at least the matrix and the base reinforcing structure; and refractory material compatible with at least the matrix and the flowable fit, such that: surfaces of the reinforcing structure are prepared for accepting the flowable fit; the flowable frit is applied to the prepared surfaces; the flowable frit is dried; the dried flowable frit is fired on the reinforcing structure at a first pre-specified temperature regime for a first pre-specified time; the resultant coated reinforcing structure is cooled; the resultant cooled enhanced reinforcing structure is heated until the coating is softened; the refractory material is applied to the surface of the softened coating; and the resultant two-part coating is fired at a pre-specified temperature regime for a pre-specified time; the resultant enhanced reinforcing structure is cooled; the resultant cooled enhanced reinforcing structure is inserted into the matrix while the matrix is flowable and the resultant flowable matrix incorporating the enhanced reinforcing structure is cured.

In select embodiments of the present invention, surfaces of the base reinforcing structure are prepared for coating by cleaning and degreasing.

In select embodiments of the present invention, the base reinforcing structure is selected from the group consisting of: metal fibers, metal rods, steel fibers, steel rods, metal alloy fibers, metal alloy rods, metal, metal alloys, steel, stainless steel, aluminum, copper, material plated with metal, and combinations thereof.

In select embodiments of the present invention, steels that may be used are selected from the group consisting of: low-carbon steel; decarburized steel; interstitial-free steel, i.e., steels in which carbon and nitrogen are contained in an alloying element such as titanium, niobium, vanadium and the like; titanium-stabilized steel, and combinations thereof.

In select embodiments of the present invention, the initially flowable matrix is a cement-based paste selected from the group consisting of: portland cement—based mortars; portland cement-based concretes; phosphate-cement based mortars; phosphate-cement based concretes; aluminum silicate cement-based mortars; aluminum silicate cement-based concretes, and combinations thereof.

In select embodiments of the present invention, frits are selected from the group consisting of: a ground glass, a ground glass slag, a fit suspended in a liquid, a glass frit suspended in a liquid, a powdered frit, a powdered glass fit, a fit containing transition metals, a frit containing cobalt, a frit containing nickel, an alkali resistant glass frit, and combinations thereof.

In select embodiments of the present invention, coatings comprise approximately equal amounts by volume of a frit and a refractory material.

In select embodiments of the present invention, the frit may be a powdered glass frit and the refractory material dry portland cement, such as a type I-II portland cement. In select embodiments of the present invention, the dry portland cement may be provided in a proportion of up to about 70% by volume of the final multi-part coating.

In select embodiments of the present invention, the final surface coating may comprise a fit suspended in a liquid and a dry refractory material in approximately equal amounts by volume of the liquid suspension and the dry refractory material.

In select embodiments of the present invention, a two-part coating may comprise equal amounts by volume of a liquid suspension of an alkali-resistant glass frit as a first part and portland cement, such as a type I-II portland cement, as a second part incorporated in the top surface of the two-part coating.

In select embodiments of the present invention, the liquid suspension of an alkali-resistant glass frit may be a commercially available enamel groundcoat.

Metal surfaces are typically prepared for groundcoat enameling using an acid etch/nickel deposition preparation process. One such process is described in Porcelain Enameling, reprinted from Metals Handbook, Volume 5, ASM Committee on Porcelain Enameling, “Nonmetallic Coating Processes,” Porcelain Enameling American Society for Metals, 1995, with permission of the American Society of Metals, by Porcelain Enamel Institute, Inc., Nashville, Tenn., pp 459-460. The acid etch/nickel deposition process involves placing components to be coated on corrosion-resistant racks and either dipping or spraying the parts with various solutions in a prescribed order and for a prescribed time at each step.

Specifically, the steps are:

1) Clean with an alkaline cleaner using a 2-step process for spray cleaning

2) Warm rinse with water

3) Cold rinse with water

4) Pickle in a warm dilute sulfuric acid solution

5) Cold rinse in a cold dilute sulfuric acid solution

6) Deposit nickel

7) Cold rinse in a cold dilute sulfuric acid solution

8) Neutralize with a suitable liquid solution having a basic pH

Table 2, as provided in Porcelain Enameling, establishes specific ranges for the above process.

TABLE 2
Ground-Coat Enameling, Acid-etch/Nickel-deposition Process.

| | | | | Cycle time | |
|---|---|---|---|---|---|
| | | | Temperature | (min) | |
| Step | Solution | Composition | (° C.) | Dip | Spray |
| 1 | Alkaline | 15-60 g/L^{b} | Ambient | 6-12 | 1-3 |
| | Cleaner^{a} | | to 100°^{c} | | |
| 2 | Warm Rinse | Water | 49-60° | 0.5-4 | 0.5-1 |
| 3 | Cold Rinse | Water | Ambient | 2-4 | 0.5-1 |
| 4 | Pickle^{d} | H₂SO₄, 6-8% | 66-71° | 5-10 | 3-5 |
| 5 | Cold Rinse | Water, H₂SO₄^{e} | Ambient | 0.5-4 | 0.5-1 |
| 6 | Nickel | NiSO₄ 6 H₂O, | 60-82° | 5-10 | 4-6 |
| | deposition^{f} | 5.6-7.5 g/L | | | |
| 7 | Cold rinse | Water, H₂SO₄^{e} | Ambient | 0.5-4 | 0.5-1 |
| 8 | Neutralize | ⅔ Na₂CO₃, | Ambient | 1-6 | 1-2 |
| | | ⅓ borax, | | | |
| | | 0.6-2.1 g/L | | | |

^{a}For spray cleaning, use a two-stage process.
^{b}For spray cleaning, use 3.8-15 g/L.
^{c}60-82° C. for spray cleaner.
^{d}Weight loss of metal is 3-5 g/m².
^{e}Maintain a pH in the solution of 3-3.5 to prevent formation of ferric iron.
^{f}Nickel deposit should be 0.2-0.6 g/m²; continuous filtration is used to remove Fe(OH)₃.

After drying at 93-150° C., steel parts treated with this process have a light straw color. When low-carbon, decarburized steel is enameled in a direct operation, the steel is etched to remove 11-22 g/m² of surface metal and receives a surface deposit of 0.9-1.3 g/m² of nickel. A ferric sulfate etching solution is sometimes used with decarburized steel.

In select embodiments of the present invention, coatings are applied via a method selected from the group consisting of: spraying, dipping, brushing, flowing on, electrostatic spraying, plasma spraying, rolling, and combinations thereof.

In select embodiments of the present invention, the temperature regime involves inserting coated reinforcing material into an oven pre-heated to the pre-specified final temperature of firing. In select embodiments of the present invention, the final temperature of firing a coating is from about 500° C. to about 900° C., and preferably from about 800° C. to about 875° C.

In select embodiments of the present invention, the time regime is that time after inserting coated reinforcing material into an oven pre-heated to the final temperature of firing until removal of the fired reinforcing material from the oven. In select embodiments of the present invention, the time of firing is selected to be from about two minutes to about 45 minutes and preferably from about 15 minutes to about 30 minutes.

In select embodiments of the present invention, the temperature required to observe softening of a fired “hardened” coating is between about two to about five minutes at the pre-specified firing temperature.

In select embodiments of the present invention, cooling of the fired reinforcing material is done by removing the fired reinforcing material from the oven and permitting the reinforcing material to reach ambient temperature in ambient air.

In select embodiments of the present invention, portland cement is employed as both the refractory material to be applied as a top surface coat to a fired and then softened enamel (glass) initially applied to the reinforcing material and as at least part of the composition of the matrix to be reinforced, i.e., concrete. Portland cement-based concrete begins as a strong alkaline paste. This paste varies in pH from about the pH of calcium hydroxide (12.5) to almost 14 depending on the amount of sodium present. This high alkalinity dictates use of fits that are alkali-resistant. Typically, alkali-resistant glass frit is made by adding zirconium to a basic silica-sodium-borate composition. Further, when a highly alkaline paste attacks a glass surface, it typically forms a gel that swells unless the fit is stabilized with a lithium compound. Existing alkali-resistant glass fits are made with both zirconium and lithium, thus, for use in a portland cement-based matrix, frits are selected from among existing (commercial) alkali-resistant frits. Some examples include “Cermet” from Thompson Enamel Co., Bellevue, Ky.; “Frit 2680 Transparent,” also from Thompson; and “F-579 Frit” from Fusion Ceramics, Inc., Carrollton, Ohio.

In select embodiments of the present invention, one or more refractory materials are added to form a top (surface) coat over one or more base coats comprising flowable frits that have been fired on the reinforcing structure. Refractory material (i.e., those inorganic materials having a melting point higher than that of the fits) may comprise portland cement clinker, mica flakes, and the like. The resultant multi-coat combination is compatible with an embedding matrix, such as a portland cement-based mortar, in which the enhanced reinforcing material is to be inserted. In select embodiments of the present invention, in addition to improving the bond, in particular the chemical bond, between the top coat of the base reinforcing material and the matrix, the one or more initially established enamel (glass) coatings may eliminate or significantly reduce the rate of corrosion of metal or metal-plated reinforcement.

In select embodiments of the present invention, at least three approaches exist for establishing an improved bond, in particular a chemical bond, of a matrix to reinforcement material embedded in the matrix. First, the embedding matrix, such as a portland cement-based concrete or mortar paste, may be designed to etch, and thus bond with a particular established glass coating (e.g., an enamel) on a reinforcement, such as rebar. Second, the glass coating on the reinforcement material may be abraded to form a rough (more chemically receptive) surface and a dry “powdered” refractory material, such as portland cement or glass slag and the like, applied to the roughened surface to enhance the bond of the reinforcement to a structural matrix, such as portland cement-based mortar or concrete. Third, a preferred approach of select embodiments of the present invention, flowable frit materials may be applied and fired as base coats yielding a glass or enamel surface, and a refractory material applied in a pre-specified manner to the glass surface, after it has been softened by heating. The resultant top (surface) coat comprises a coarse enamel that is subsequently fired. The multi-coat coarse topcoat-enameled reinforcement material is permitted to cool and then inserted in an initially flowable matrix, such as a paste of a portland cement-based mortar or concrete. The matrix is allowed to cure and the strength of the matrix has been shown to increase even subsequent to the conventional 28-day cure of conventional rebar-reinforced concrete.

In select embodiments of the present invention, equal volumes of a ground glass fit, preferably an alkali-resistant frit, and portland cement are provided to prepare a coarse final two-coat corrosion resistant bonding surface. In select embodiments of the present invention, the glass may be a mixture of glass types such as are available from a recycling plant. More than 50% by volume portland cement may be used. In select embodiments of the present invention, up to about 70% by volume of the coarse final top (surface) coat may be portland cement. In select embodiments of the present invention, the texture of the coarse surface may range from a fine sand, such as a quartz sand, to a fine powder, such as portland cement.

In select embodiments of the present invention, a “ground glass” coarse top-coat bonding surface is applied to a corrosion and alkali-resistant base coat fired on the reinforcing material. The top coat comprises a slurry of ground glass and a bulk refractory material, such as portland cement, using water or water mixed with a thickener or adhesive, such as methyl cellulose. The basecoat-enameled reinforcing item, such as a steel rebar, may be top-coated by dipping, spraying, brushing, rolling or flow coating the slurry onto the surface. The resultant wet top coating is typically air-dried prior to firing.

Further, select embodiments of the present invention for preparing a corrosion resistant multi-coat enamel having a coarse final bonding surface may be used to prepare separate surfaces to be strongly bonded, each surface incorporating the rough (coarse) enameled surface at the interface to be joined. The two surfaces may be joined at ambient conditions by applying a suitable flowable matrix, such as a portland cement-based grout, as an adhesive.

In select embodiments of the present invention, a method of improving corrosion resistance and enhancing bonding, in particular chemical bonding, between materials comprises: selecting first and second surfaces to be bonded; selecting one or more first flowable frits compatible with material comprising the first surface; preparing the first surface for enameling; applying a first flowable fit to the first surfaces; allowing the first flowable fit to dry; firing the dried first flowable frit on the first surface at a pre-specified temperature for a pre-specified period to achieve a first enamel (glass) surface; allowing the first enamel surface to cool; selecting first refractory material compatible with the fired first frit; softening the first enamel surface by heating; applying the first refractory material to the first enamel surface to yield a first coarse topcoat; firing the first coarse topcoat to yield a first coarse enamel topcoat; selecting one or more second flowable frits compatible with the material comprising the second surface; preparing the second surface for enameling; applying a second flowable frit to the second surface; allowing the second flowable fit to dry; firing the dried second flowable frit on the second surface at a pre-specified temperature for a pre-specified period to achieve a second enamel (glass) surface; allowing the second enamel surface to cool; selecting second refractory material compatible with the fired second frit; softening the second enamel surface by heating; applying the second refractory material to the second enamel surface to yield a second coarse topcoat; firing the second coarse topcoat to yield a second coarse enamel topcoat; and applying grout to one of the first and second fired surfaces; bringing the grouted surface in contact with the un-grouted surface to effect a bond between the first and second surfaces; and curing the grout.

### Example I

In laboratory tests, a bonding-frit coating (enamel) was prepared by mixing about 50% by volume of a portland cement type I-II with 50% by volume of a commercial alkali-resistant ground coat enamel to yield liquid coating. In select testing, this coating was applied to the experimental rods and fired at temperatures from about 805-870° C. for times ranging from about 2 to about 12 minutes. The firing produced a coarse-textured enamel about 50-100 μm (2-4 mils) thick, including the refractory material embedded therein. Thin spots were corrected by applying more liquid coating to the thin areas and firing a second time using the same temperature and time regimes. This method of firing a single coating established an improved bond, including a chemical bond, between the reinforcing material and the matrix, but may not be optimum for improving corrosion resistance.

### Example II

Two sets of smooth (not “ridged” as with conventional rebar) AISI C1018 steel rods, 72 mm in length and 6.35 mm in diameter, were treated in accordance with an embodiment of the present invention. Unmodified rods were threaded at one end and used as a control. These control rods (threaded version not shown separately) were cleaned with oxalic acid and water, rinsed with tap water, rinsed with dilute sulfuric acid, rinsed with distilled water, and given a final rinse of alcohol and allowed to air dry.

The surfaces of experimental steel rods “enhanced” in accordance with an embodiment of the present invention were prepared by: cleaning with an alkali-based solution; water rinsing preferably with warm water (in a range of about 45-60° C.); water rinsing, preferably with cold water (ambient, i.e., about 15-25° C.); acid-etching in a sulfuric acid solution of about 6-8%; cold rinsing with a dilute sulfuric acid solution of pH of about 3.0-3.5; nickel deposition at about 0.02 to 0.06 g/m² as described above from Porcelain Enameling; cold rinsing in a dilute sulfuric acid solution of pH about 3.0-3.5; and final rinsing in a sodium carbonate/sodium borate solution.

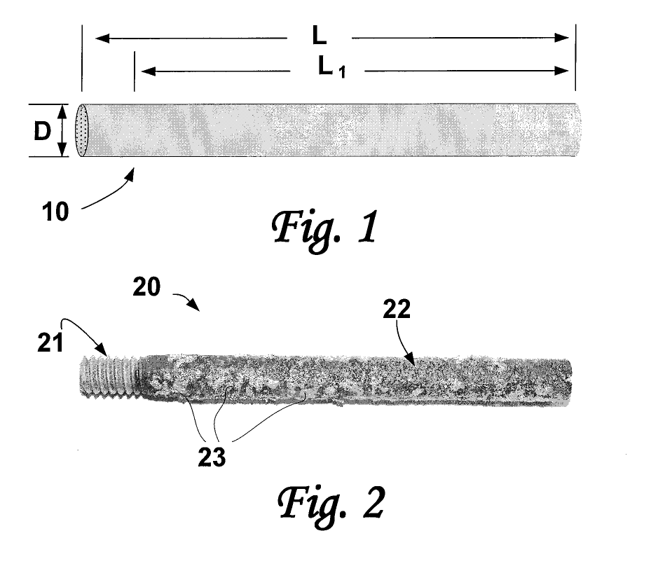

Refer to FIG. 1 describing the dimensions of the control and experimental rods used, where Lᵢ=65 mm, L=72 mm and D=6.5 mm. All rods 10 were threaded for about 7 mm (L-L₁) of their length, L, similar to threading 21 of FIG. 2. The rods 10 were threaded to facilitate “pull out” testing.

Refer to FIG. 2 depicting a photograph of one of the coated (glazed) and fired experimental rods 20. None of the experimental rods 20 were abraded. The experimental rods were dipped into a water-based suspension of commercial glass frit (VitrearcTransparent Prussian Blue Cat. No. 2680, Thompson Enamel Co., Bellevue, Ky.), portland cement, and methyl cellulose thickener (Klyr-Fire #A-1, Thompson-Enamel Co., Bellevue, Ky.). After coating (glazing) with the commercial glass frit, the experimental rods 20 were permitted to air-dry and then fired in an electric furnace to achieve a smooth enamel (glass) finish. After firing, the experimental rods 20 were allowed to air cool. The cooled enameled rods 20 were then heated to soften the enamel and dry portland cement Type I-II was applied to the softened surface by sprinkling the surface. The rods 20 were then fired to achieve a coarse outer surface in which the portland cement was embedded. Thus, portions of the resultant surface enamel 22 are portland cement embedded in a cobalt-doped blue glass and appear as light-colored areas 23 in the coarse enamel 22. The furnace temperature for the final firing of the rod 20 of FIG. 2 was 816° C., maintained for 30 minutes. For other experimental rods 20, the rods 20 were coated the same as for the rod 20 pictured in FIG. 2 but maintained at 745° C. for approximately 15 minutes.

For “pull-out testing,” the rods 10, 20 (control and treated) were inserted to a depth of 65 mm in a 76 mm (3 in) diameter, 152 mm (6 in) long cylinder containing a portland cement-based mortar paste. The standard mortar described in the ASTM C 109 section on proportioning was used to prepare the mortar cylinders. After the rods 10, 20 were inserted in the mortar paste; each cylinder was consolidated by vibrating the mortar paste for thirty seconds. All cylinders were moist-cured for seven days.

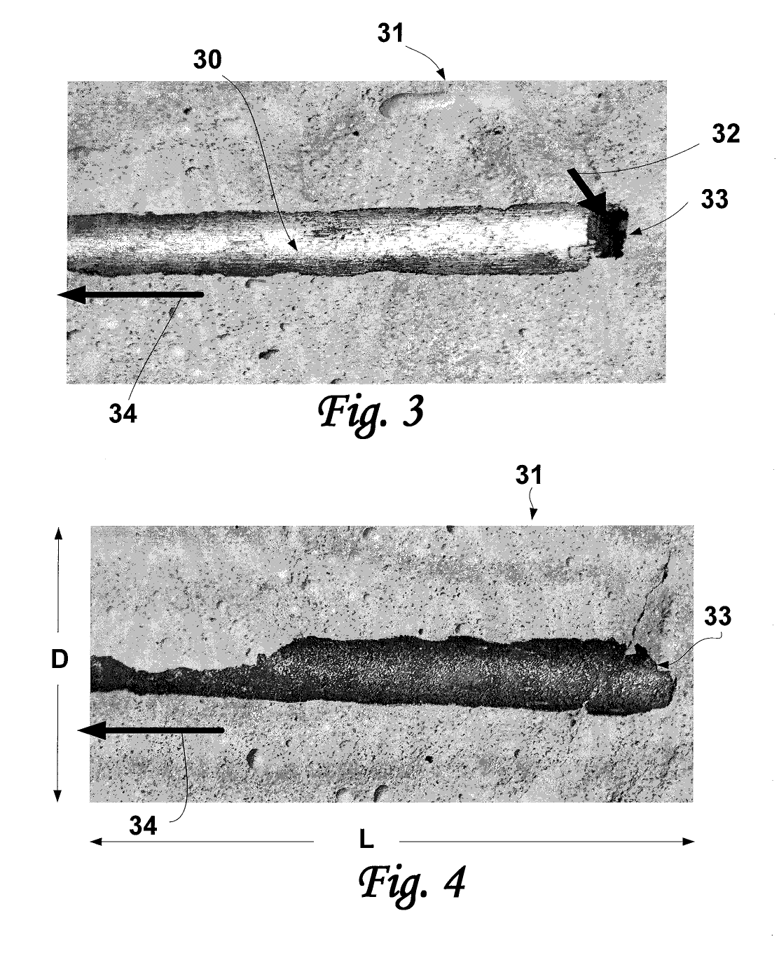

Refer to FIG. 3, a photograph of a section 31 of a typical cylinder split lengthwise along one side of the inserted rod 30. In this photo, the rod 30 has been extracted in the direction of the arrow 34 only a short distance as indicated at the arrow 32 to show a small portion of the void 33 resultant from extraction. FIG. 3 also shows how the experimental rod 30 was stripped completely of its glaze 22. This demonstrates that the chemical bond between the concrete and the coarse enamel is stronger than the bond between the coarse enamel and the steel rod or steel rebar. Heretofore, the rebar would pull clear of the concrete itself, the coating, if any, on the rebar, being more strongly affixed to the rebar than to the concrete matrix.

Refer to FIG. 4, a view of the mortar section 31 of FIG. 3 with the rod 30 removed completely. The darkened area is the entire void 33 showing the fired glaze 22 remaining attached within the mortar matrix 31 after the experimental rod 30 was pulled out, i.e., the bond of the coarse enamel 22 to the mortar section 31 was stronger than the bond of the coarse enamel 22 to the steel rod 30.

After moist curing, the adhesion between the mortar and the rods 10, 20 was determined by measuring the peak load required to pull the rods free from the mortar such that peak load equaled break load. The results of the testing are presented in Table 3. The load required for pull-out was measured by using an MTS Material Testing System (Minneapolis Minn.).

TABLE 3
Results of Pull-out Test of Steel Rods in Moist-Cured Mortar

| | Break Load |
|---|---|
| Specimen | (lbf) |
| Control #1 | 735.9 |
| Control #2 | 136.8 |
| Control #3 | 749.4 |
| Control #4 | 929.7 |
| Mean | 638.0 |
| Std Deviation | 345.6 |
| Frit #1 w/PC (700° C.) | 1927.0 |
| Frit #2 w/PC (700° C.) | 1936.3 |
| Frit #3 w/PC (700° C.) | 1441.5 |
| Mean | 1768.3 |
| Std Deviation | 283.0 |

Results for the control rods 10 were similar to those obtained with earlier tests with similar uncoated rods. The greatest adhesion between the coated experimental rods 20 and the mortar 31 was noted with the experimental rods 20 that were treated with a coating (glaze) containing a fit-bonding mixture of a glass fit first fired on the rod 20, cooled, and then re-heated to softening and coated with a portland cement sprinkled on the heat-softened base coat and then fired on the rod 20. This final coarse enamel (glass) produced adhesion to the concrete that was nearly three times greater than that measured for the control rods 10.

In select embodiments of the present invention, the fired coarse enamel of select embodiments of the present invention performs better than the fusing of portland cement to an established enamel or abrading enamel and fusing portland cement, the latter two described above as approaches one and two, respectively.

In summary, investigation proved that it is possible to bond grains of portland cement in mortar paste to portland cement grains, or any refractory mineral phases such as mica or quartz, that are chemically bonded to an enamel fired on steel. The bond thus achieved between enameled rebar and concrete significantly improves the steel reinforcement of conventional concrete structures such as roadways, bridge decks, foundations, and the like.

The abstract of the disclosure is provided to comply with the rules requiring an abstract that will allow a searcher to quickly ascertain the subject matter of the technical disclosure of any patent issued from this disclosure. 37 CFR §1.72(b). Any advantages and benefits described may not apply to all embodiments of the invention.

While the invention has been described in terms of some of its embodiments, those skilled in the art will recognize that the invention can be practiced with modifications within the spirit and scope of the appended claims. For example, although the system is described in specific examples for improving the bond of reinforcement in cement-based matrices, it may apply to any number of applications including structure that may not employ a cement-based matrix but that does utilize reinforcement bonded thereto. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Thus, it is intended that all matter contained in the foregoing description or shown in the accompanying drawings shall be interpreted as illustrative rather than limiting, and the invention should be defined only in accordance with the following claims and their equivalents.

We claim:

1. A multi-coat configuration applied to reinforcing material for improving the physical and chemical bond between said reinforcing material and an initially flowable matrix incorporating said reinforcing material, comprising:
at least one flowable frit compatible with said matrix and said reinforcing material;
wherein a first said at least one flowable frit is applied to said reinforcing material and fired thereon to create a first corrosion resistant enamel surface, and
refractory material chemically reactive with at least said matrix and compatible with said at least one flowable
wherein said refractory material is added to a heat-softened top surface of said first corrosion resistant enamel surface to yield a multi-coat coarse enamel surface, and wherein said multi-coat coarse enamel surface is fired on said reinforcing material at a pre-specified temperature for a pre-specified time.

2. The configuration of claim 1 in which said reinforcing material is material selected from the group consisting of: metal fibers, metal rods, steel fibers, steel rods, metal alloy fibers, metal alloy rods, metal, metal alloys, steel, stainless steel, aluminum, copper, material plated with metal, and combinations thereof.

3. The configuration of claim 2 in which said steel, steel fibers and steel rods are selected from the group consisting of: low-carbon steel; decarburized steel; interstitial-free steel, titanium-stabilized steel, and combinations thereof.

4. The configuration of claim 1 in which said initially flowable matrix comprises cement-based pastes selected from the group consisting of: portland cement-based mortars; portland cement-based concretes; phosphate-cement based mortars; phosphate-cement based concretes; aluminum silicate cement-based mortars; aluminum silicate cement-based concretes, and combinations thereof.

5. The configuration of claim 1 in which said frit is selected from the group consisting of: a ground glass, a ground glass slag, a fit suspended in a liquid, a glass fit suspended in a liquid, a frit suspended in a liquid incorporating a thickener, a powdered frit, a powdered glass frit, a frit containing transition metals, a frit containing cobalt, a fit containing nickel, a frit containing lithium, a frit containing zirconium, an alkali-resistant glass frit, an alkali-resistant groundcoat enamel, and combinations thereof.

6. The configuration of claim 1 in which a top said coating comprises at least in part a mixture of at least one powdered glass fit and at least one dry refractory material.

7. The configuration of claim 1 in which at least one said coating comprises at least in part a mixture of dry portland cement and a powdered alkali-resistant glass frit.

8. The configuration of claim 7 in which said powdered alkali resistant glass fit is at least one commercially available enamel groundcoat.

9. The configuration of claim 1 in which a topmost of said coatings is a mixture of at least one liquid glass frit suspension and at least one dry refractory material.

10. The configuration of claim 9 in which at least one said dry refractory material is dry portland cement and at least one said liquid glass fit suspension is a liquid alkali resistant glass frit suspension.

11. The configuration of claim 10 in which said liquid alkali resistant glass fit suspension is at least one commercially available enamel groundcoat.

12. The configuration of claim 1 in which at least one of said coatings is a mixture of a volume amount of said fits approximately equal to a volume amount of said refractory material,
wherein a topmost of said coatings comprises at least one said frit into which has been added at least one said refractory material upon heating to softening said at least one said frit and firing the resultant topmost mixture to achieve a coarse enamel topcoat.

13. The configuration of claim 1 in which a topmost said coating is a mixture of up to approximately 70% by volume of dry portland cement and as little as approximately 30% by volume of powdered alkali resistant glass frit.

14. The configuration of claim 1 in which at least one said coating is applied via a method from the group consisting of: spraying, dipping, brushing, flowing on, electrostatic spraying, rolling, plasma spraying, and combinations thereof.

15. A reinforcing structure incorporating an improved bonding surface to an initially flowable matrix incorporating said reinforcing structure, comprising:
a base material having an external surface;
at least one flowable frit compatible with said matrix and said external surface; and
refractory material compatible with at least said matrix and said at least one flowable frit,
wherein said surface is prepared for accepting said at least one flowable frit, and
wherein at least one said flowable frit is applied to said prepared surface, and
wherein said at least one flowable frit is allowed to dry on said surface, and
wherein said dried at least one flowable frit is fired on said surface at a pre-specified temperature for a pre-specified time to achieve an enameled surface, and
wherein said resultant enameled surface is cooled, and
wherein said resultant cooled enameled surface is heated to softening, and
wherein said refractory material is applied to said softened enameled surface and fired at a pre-specified temperature for a pre-specified time to achieve a coarse enameled surface, and
wherein the resultant coarse enameled surface is cooled to ambient temperature.

16. The reinforcing structure of claim 15 in which said base material is selected from the group consisting of: metal fibers, metal rods, steel fibers, steel rods, metal alloy fibers, metal alloy rods, metal, metal alloys, steel, stainless steel, aluminum, copper, material plated with metal, and combinations thereof.

17. The reinforcing structure of claim 16 in which said steel, steel fibers and steel rods are selected from the group consisting of: low-carbon steel; decarburized steel; interstitial-free steel, titanium-stabilized steel, and combinations thereof.

18. The reinforcing structure of claim 15 in which said initially flowable matrix comprises cement-based pastes selected from the group consisting of: portland cement-based mortars; portland cement-based concretes; phosphate-cement based mortars; phosphate-cement based concretes; aluminum silicate cement-based mortars; aluminum silicate cement-based concretes, and combinations thereof.

19. A method of enhancing bonding between first and second surfaces, while improving corrosion resistance at the bond, comprising:
selecting a first flowable frit compatible with said first surface;
selecting first refractory material compatible with at least said first surface and said first flowable frit;
preparing said first surface to receive said first flowable frit;
applying said first flowable frit to said first surface;
allowing said first flowable fit to dry on said first surface;
selecting a second flowable fit compatible with said second surface;
selecting second refractory material compatible with at least said second surface and said second flowable fit;
preparing said second surface to receive said second flowable frit;
applying at least one said second coating to said second surface;
selecting at least one temperature regime each for firing said first and second coatings onto said first and second surfaces, respectively;
selecting a time regime for conducting each of said firings of said first and second coatings;
firing said first and second coatings onto said first and second surfaces respectively at respective said temperature regimes for the duration of respective said time regimes;
cooling said fired first and second surfaces to achieve respective first and second enameled surfaces;
heating said first and second enameled surfaces to softening;
applying said first refractory material to said first softened enameled surface to achieve a first coarse coating;
applying said second refractory material to said second softened enameled surface to achieve a second coarse coating;
firing said first and second course coatings at respective first and second temperature regimes for respective first and second time periods to achieve respective first and second final coarse enameled surfaces;
cooling said first and second final coarse enameled surfaces to ambient temperature;
applying grout to one of said first and second final coarse enameled surfaces;
bringing said grouted final coarse enameled surface in contact with the other final coarse enameled surface to effect a bond between said first and second surfaces; and
curing said grout.

20. The method of claim 16 preparing said first and second surfaces by:
cleaning with an alkali-based solution;
rinsing with water maintained at a temperature of about 45 to about 60° C.;
rinsing with water maintained at ambient temperature of about 15 to about 25° C.;
acid-etching in a sulfuric acid solution of about 6 to about 8%;
rinsing with a dilute sulfuric acid solution at pH of about 3.0 to about 3.5;
depositing nickel at about 0.02 to about 0.06 g/m²;
rinsing at ambient temperature of about 15 to about 25° C. in a dilute sulfuric acid solution of pH about 3.0 to about 3.5; and
final rinsing in a sodium carbonate/sodium borate solution.
